(19) United States
(12) Patent Application Publication
(10) Pub. No.: US 2016/0368458 A1
(43) Pub. Date: Dec. 22, 2016

(54) THERMOELECTRIC DEHUMIDIFYING APPARATUS

(71) Applicant: Hyundai Motor Company, Seoul (KR)

(72) Inventors: Man Ju Oh, Yongin-Si (KR); Jae Woo PARK, Ansan-Si (KR); Jae Woong KIM, Hwaseong-Si (KR)

(73) Assignee: Hyundai Motor Company, Seoul (KR)

(21) Appl. No.: 14/934,010

(22) Filed: Nov. 5, 2015

(30) Foreign Application Priority Data
Jun. 16, 2015 (KR) 10-2015-0085415

(51) Int. Cl. B60S 1/02; F24F 5/00

(52) U.S. Cl. CPC B60S 1/023; F24F 5/0042

(57) ABSTRACT

A thermoelectric dehumidifying apparatus may include a housing provided in a widthwise direction of a vehicle adjacent to a windshield glass of the vehicle and having an inlet and an outlet at an upper end thereof, a thermoelectric module including a thermoelectric element provided between the inlet and the outlet in an interior of the housing and having a surface with which cooling fins make surface-contact and an opposite surface with which heat radiation fins make surface-contact, wherein the thermoelectric element is disposed on a passage of air flowing from the inlet to the outlet such that the air introduced through the inlet passes by the cooling fins and the heat radiation fins at a same time and then is discharged through the outlet, and a fan provided in the interior of the housing, for guiding the air from the inlet to the outlet.

### CROSS-REFERENCE(S) TO RELATED APPLICATION

The present application claims priority to Korean Patent Application No. 10-2015-0085415, filed Jun. 16, 2015, the entire contents of which is incorporated herein for all purposes by this reference.

### BACKGROUND OF THE INVENTION

Field of the Invention

The present invention relates to an air conditioning apparatus for a vehicle, and more particularly, to a dehumidifying apparatus in an interior of a vehicle using a thermoelectric element.

Description of Related Art

When the humidity of the interior of a vehicle is high or a temperature difference between the interior and the exterior of the vehicle is large, humid air is condensed while contacting the front windshield glass of the vehicle such that the temperature of the air is lowered and the saturation humidity of the air is lowered. The humid air may be ventilated or the moisture may be physically wiped off and removed according to situations, but because it consumes much time, when the field of view of the driver is hampered or the driver drives alone, an accident may occur during driving of the vehicle due to carelessness of the driver.

In order to solve the above-mentioned problem, the temperature difference between the interior and the exterior of the vehicle may be reduced by performing heating air conditioning in summer and performing cooling air conditioning in winter, but this method consumes much time in removing already generated moisture and consumes much energy, which decreases efficiency.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a thermoelectric dehumidifying apparatus that directly suctions interior air around a windshield glass of a vehicle, air-conditions the air using a thermoelectric element, and discharges the air again, thereby rapidly eliminating moisture of the windshield glass.

According to various aspects of the present invention, a thermoelectric dehumidifying apparatus may include a housing provided in a widthwise direction of a vehicle adjacent to a windshield glass of the vehicle and having an inlet and an outlet at an upper end thereof, a thermoelectric module including a thermoelectric element provided between the inlet and the outlet in an interior of the housing and having a surface with which cooling fins make surface-contact and an opposite surface with which heat radiation fins make surface-contact, wherein the thermoelectric element is disposed on a passage of air flowing from the inlet to the outlet such that the air introduced through the inlet passes by the cooling fins and the heat radiation fins at a same time and then is discharged through the outlet, and a fan provided in the interior of the housing, for guiding the air from the inlet to the outlet.

The inlet of the housing may be formed closer to the windshield glass of the vehicle than the outlet.

The housing may have a closed structure such that air circulates through the inlet and the outlet.

The cooling fins and the heat radiation fins of the thermoelectric module may extend upwards and downwards.

A water drainage hole may be formed at a lower end of the housing.

The thermoelectric module may be disposed on a side close to the inlet and the fan may be disposed on a side close to the outlet.

The heat radiation fins of the thermoelectric module may have an air contact area wider than that of the cooling fins.

A heat transfer mass may surface-contact the opposite surface of the thermoelectric element and a heat transfer pipe may be coupled to pass through the heat transfer mass and extend in a widthwise direction of the vehicle in the interior of the housing, and the heat radiation fins may be provided at an extending portion of the heat transfer pipe.

A plate-shaped heat transfer plate extending in a widthwise direction of the vehicle to be coupled may be provided on the opposite surface of the thermoelectric element, and the heat radiation fins may be coupled to the heat transfer plate.

The cooling fins and the heat radiation fins may be arranged to coincide with a flow direction of the air.

An insulation partition may be provided between the cooling fins and the heat radiation fins in the interior of the housing.

The insulation partition may surround the cooling fins to spatially separate the cooling fins and the heat radiation fins.

The fan may be a cross fan disposed in a widthwise direction of the vehicle.

A front side and an upper side of the housing may be opened with respect to the vehicle, a cross fan housing, an upper side and a rear side of which are opened with respect to the vehicle may be provided, and the front side of the housing and the rear side of the cross fan housing may be coupled to each other to be closed, so that air can circulate through the inlet and the outlet on the upper side of the housing.

As described above, the thermoelectric dehumidifying apparatus according to the present invention can directly circulate interior air around a windshield glass and air-conditions the air, thereby rapidly eliminating moisture.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary thermoelectric dehumidifying apparatus according to the present invention.

FIG. 2 is an exploded perspective view of the exemplary thermoelectric dehumidifying apparatus according to the present invention.

FIG. 3 is an exploded perspective view of a thermoelectric module according to the present invention.

FIG. 4 is an exploded perspective view of an exemplary thermoelectric module according to the present invention.

FIG. 5 is a sectional view of the exemplary thermoelectric dehumidifying apparatus of FIG. 1, which is taken along line A-A.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

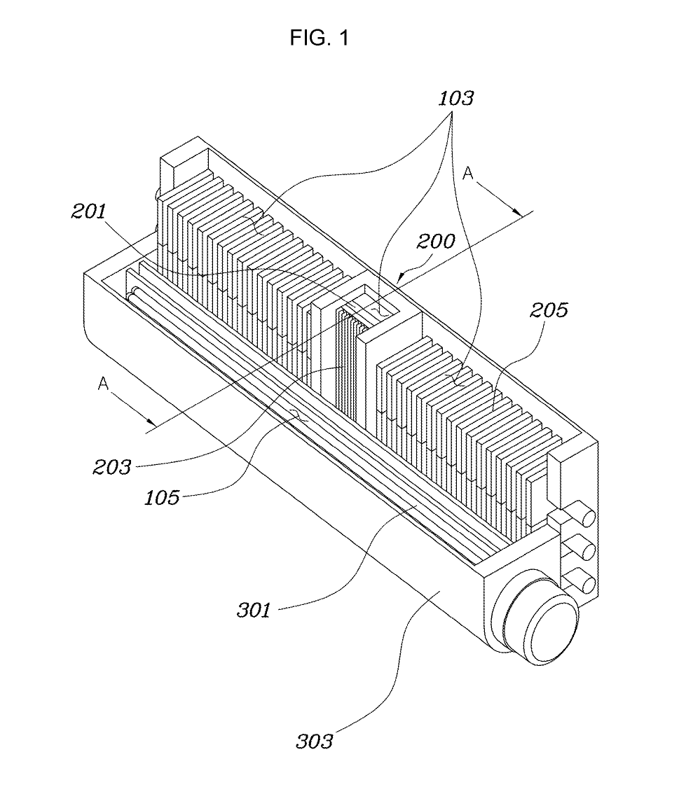

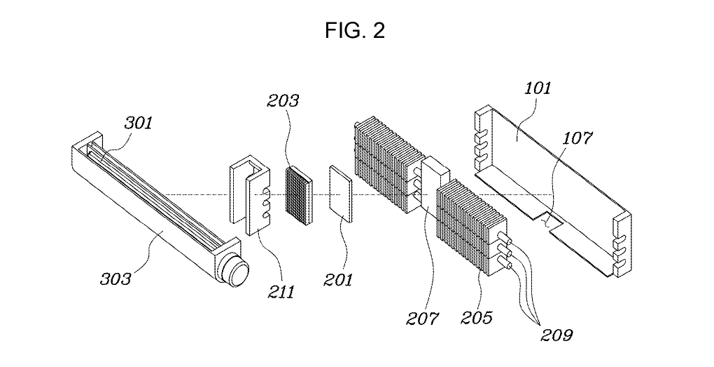

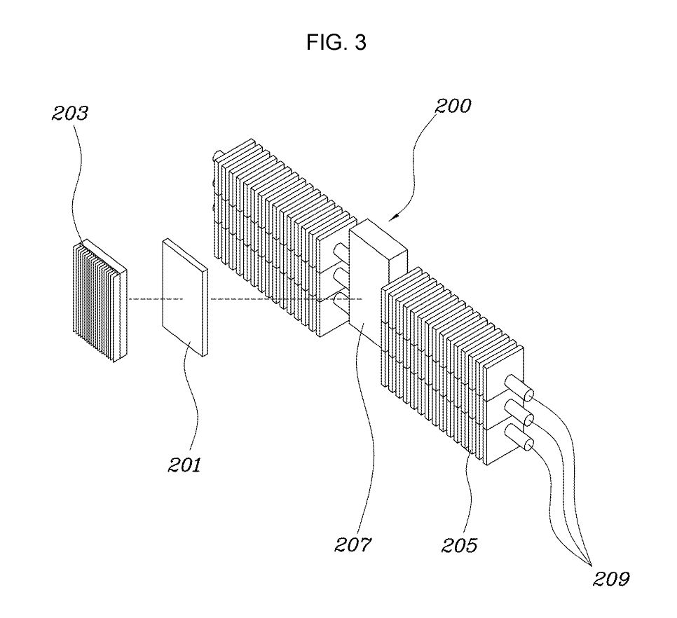

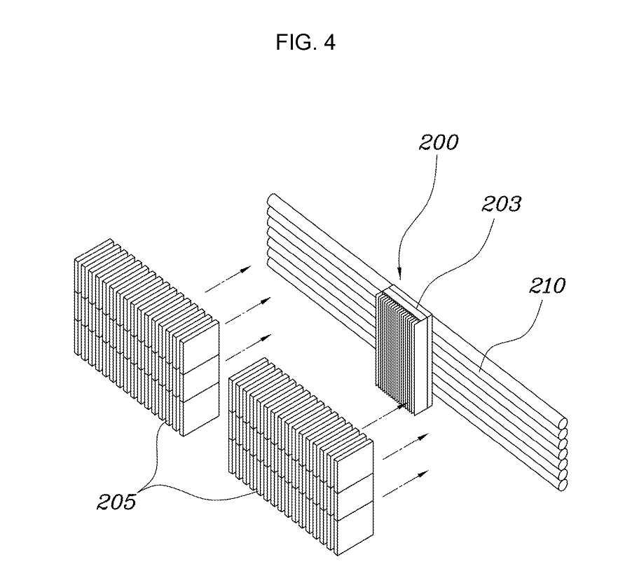

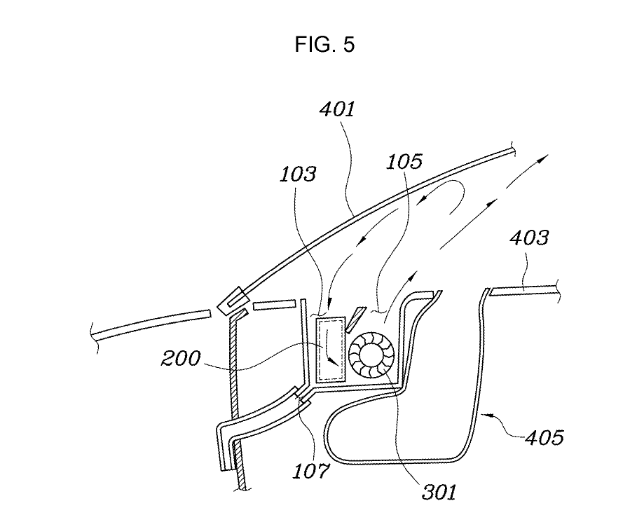

FIG. 1 is a perspective view of a thermoelectric dehumidifying apparatus according to various embodiments of the present invention. FIG. 2 is an exploded perspective view of the thermoelectric dehumidifying apparatus according to various embodiments of the present invention. FIG. 3 is an exploded perspective view of a thermoelectric module 200 according to various embodiments of the present invention. FIG. 4 is an exploded perspective view of a thermoelectric module 200 according to various embodiments of the present invention. FIG. 5 is a sectional view of the thermoelectric dehumidifying apparatus of FIG. 1, which is taken along line A-A.

The thermoelectric dehumidifying apparatus includes a housing 101 provided in a widthwise direction of a vehicle adjacent to a windshield glass 401 of the vehicle and having an inlet 103 and an outlet 105 at an upper end thereof, a thermoelectric module 200 including a thermoelectric element 201 provided between the inlet 103 and the outlet 105 in the interior of the housing 101 and having one surface with which cooling fins 203 make surface-contact and an opposite surface with which heat radiation fins 205 make surface-contact, wherein the thermoelectric element 201 is disposed on a passage of air flowing from the inlet 103 to the outlet 105 such that the air introduced through the inlet 103 passes by the cooling fins 203 and the heat radiation fins 205 at the same time and then is discharged through the outlet 105, and a fan 301 provided in the interior of the housing 101, for guiding the air from the inlet 103 to the outlet 105.

The housing 101 is provided in the widthwise direction of the vehicle adjacent to the windshield glass 401 of the vehicle, and has the inlet 103 and the outlet 105 at an upper end thereof. The thermoelectric module 200 is provided between the inlet 103 and the outlet 105 in the interior of the housing 101, and includes the thermoelectric element 201 having one surface with which the cooling fins 203 make surface-contact and an opposite surface with which the heat radiation fins 205 make surface-contact. One surface of the thermoelectric element 201 is a cooling surface, and an opposite surface thereof is a heating surface. The thermoelectric element 201 is disposed on a passage of the air flowing from the inlet 103 to the outlet 105 such that the air introduced through the inlet 103 passes by the cooling fins 203 and the heat radiation fins 205 at the same time and then is discharged through the outlet 105. The fan 301 is provided in the interior of the housing 101 to guide the air from the inlet 103 to the outlet 105.

Referring to FIGS. 1 and 2, the present invention replaces the functions of a heater core and an evaporation core according to the related art using the thermoelectric element 201, the cooling fins 203, and the heat radiation fins 205. The air passes by the cooling fins 203 and the heat radiation fins 205 at the same time, not in a sequential manner in which air is cooled and reheated or heated and cooled again, so that vent resistance may be reduced and a circulation path for air may be simplified. Through this, the air around the windshield glass 401 is rapidly and repeatedly circulated so that the air may be dehumidified for a short time.

The inlet 103 of the housing 101 may be formed closer to the windshield glass 401 of the vehicle than the outlet 105. The housing 101 has a closed structure, and air may circulate only through the inlet 103 and the outlet 105.

Referring to FIG. 5, the thermoelectric dehumidifying apparatus is a separate apparatus from a defrost unit 405 mounted on the vehicle, and may dehumidify local air around the windshield glass 401 while rapidly circulating the air. Furthermore, because the inlet 103 is formed adjacent to the windshield glass 401, the air around the windshield glass 401 that comes to have a lower saturation humidity and a higher relative humidity as the air makes contact with the windshield glass 401 such that the temperature thereof becomes lower is introduced first, so that the absolute humidity of the air is lowered by condensing the humidity of the air through the cooling fins 203 and the relative humidity of the air is lowered by heating the air through the heat radiation fins 205 and then the air is discharged through the outlet 105, whereby the humidity of the windshield glass 401 may be effectively eliminated.

The thermoelectric humidifying apparatus according to the present invention is connected to a heater control such that an operation thereof may be determined. The heater control determines whether only the fan 301 will be operated or both the fan 301 and the thermoelectric module 200 will be operated according to the operation condition of a humidity sensor and a wiper switch installed in the vehicle. For example, when the relative humidity of the air gradually increases, the process proceeds from the step of operating only the fan 301 to the step of operating both the fan 301 and the thermoelectric module 200. Furthermore, when a rainy condition is assumed, that is, if the wiper switch is operated, both the fan 301 and the thermoelectric module 200 are controlled to be operated for a predetermined time period.

The cooling fins 203 and the heat radiation fins 205 of the thermoelectric module 200 may extend upwards and downwards.

Referring to FIGS. 1 and 2, because the cooling fins 203 extend upwards and downwards, the moisture condensed on surfaces of the cooling fins 203 is naturally concentrated on lower ends of the cooling fins 203 by gravity and drop to the housing 101. Because the heat radiation fins 205 are disposed in perpendicular to the upward/downward direction of the vehicle in correspondence to the shapes of the cooling fins 203, a larger air contact surface can be secured while the heat radiation fins 205 do not hamper the flows of the air.

A water drainage hole 107 may be formed at a lower end of the housing 101.

Referring to FIG. 5, without the water drainage hole 107, the moisture condensed on the surfaces of the cooling fins 203 and then collected on the bottom of the housing 101 cannot be discharged and in this case, the dehumidified air may be humidified again, and when the amount of the collected moisture becomes larger, the collected moisture may be spattered into the interior of the air again, so that the phenomenon can be prevented by the water drainage hole 107.

The thermoelectric module 200 may be disposed on a side close to the inlet 103, and the fan 301 may be disposed on a side close to the outlet 105.

Referring to FIG. 1, when the fan 301 is arranged in the inlet 103, the air may be freely introduced but may not be freely discharged due to the vent resistance of the thermoelectric module 200, so that turbulences occur in the interior of the apparatus and thus the air may not smoothly circulate. Meanwhile, because the air may be leaked when the fan 301 is arranged in the outlet 105 as in the present invention, the air may smoothly circulate.

The heat radiation fins 205 of the thermoelectric module 200 may have an air contact area wider than that of the cooling fins 203.

The dehumidifying methods include a method of condensing the moisture in the air and lowering the absolute humidity of the discharged air and a method of increasing the temperature of the air to increase the saturation humidity of the air and lowering the relative humidity of the air. Then, the method of lowering the absolute humidity is more efficient than the method of lowering the relative humidity, and to this end, the temperature of the cooling fins 203 should be lower than the dew point of the air such that the moisture may be easily condensed. If a current flows through the thermoelectric module 200, a temperature difference occurs between one surface and an opposite surface of the thermoelectric module 200, and then if the heat of the opposite surface of the thermoelectric module is dissipated such that the temperature thereof is lowered, the temperature of the one surface is further lowered. Accordingly, it is very important to dissipate the temperature of the opposite surface of the thermoelectric module 200. Referring to FIG. 2, the cooling fins 203 are made small such that the moisture in the air may be sufficiently condensed to form a low temperature, and the side surfaces of the heat radiation fins 205 that are required to diffuse heat relatively rapidly are formed wide.

A thermoelectric mass 207 makes surface-contact the opposite surface of the thermoelectric element 201 and a thermoelectric pipe 209 is coupled to pass through the thermoelectric mass 207 and extends in a widthwise direction of the vehicle, and the heat radiation fins 205 may be provided at an extending portion of the thermoelectric pipe 209.

Referring to FIGS. 1 and 2, a structure by which air circulates via the cooling fins 203 and the heat radiation fins 205 at the same time for rapid circulation of indoor air is provided, and the structure is installed between a lower end of the windshield glass 401 and a narrow space of a crush pad 403 of the vehicle, so that the thickness thereof may be reduced. Because when fins are directly attached to the opposite surface of the thermoelectric element 201, a dead space is formed in relation to the cooling fins 203 and the heat of the opposite surface of the thermoelectric element 201 may not be transferred to ends of the heat radiation fins 205, the heat transfer mass 207 and the thermoelectric pipe 209 can help diffuse the heat to the heat radiation fins 205 and secure the practicality of the spatial utilization in relation to the cooling fins 203, as illustrated in FIG. 2.

A plate-shaped heat transfer plate 210 extending in a widthwise direction of the vehicle to be coupled is provided on the opposite surface of the thermoelectric device 201, and the heat radiation fins 205 may be coupled to the heat transfer plate 210.

Referring to FIG. 4, a separate heat transfer mass 207 is not necessary, and a coupling structure between the heat transfer plate 210 and the heat radiation fins 205 may also be simplified and thus heat may be smoothly transferred to opposite ends of the heat radiation fins 205 on the opposite surface of the heat transfer plate 210.

The cooling fins 203 and the heat radiation fins 205 may be arranged to coincide with the flow direction of the air.

Referring to FIG. 1, because the cooling fins 203 and the heat radiation fins 205 are arranged to coincide with the flow direction of the air, an area for heat exchange may be maximized while the flow of the air is not interrupted.

An insulation partition 211 may be provided between the cooling fins 203 and the heat radiation fins 205 in the interior of the housing. The insulation partition 211 surrounds the cooling fins 203 to spatially separate the cooling fins 203 and the heat radiation fins 205.

Referring to FIG. 2, because an unnecessary heat exchange occurs between the cooling fins 203 and the heat radiation fins 205 without the insulation partition 211, deteriorating air conditioning efficiency, the insulation partition 211 may prevent the phenomenon, increasing air conditioning efficiency. Furthermore, because the insulation partition 211 is pressed and coupled to the cooling fins 203 while surrounding the cooling fins 203, a space between the insulation partition 211 and the cooling fins 203 may be prevented so that heat may be efficiently transferred.

The fan 301 may be a cross fan type installed in a widthwise direction of the vehicle.

Referring to FIGS. 1 and 2, the cross fan may generate a wide air flow in a widthwise direction of the vehicle at a lower end of the windshield glass 401 as in the present invention.

A front side and an upper side of the housing 101 is opened with respect to the vehicle, a cross fan housing 303, an upper side and a rear side of which are opened with respect to the vehicle is provided, and the front side of the housing 101 and the rear side of the cross fan housing 303 are coupled to each other to be closed, so that air can circulate only through the inlet 103 and the outlet 105 on an upper side thereof.

Referring to FIGS. 1 and 2, when the housing 303 at the cross fan is configured as a separate part, it may be easily disassembled and assembled and may be easily maintained later.

For convenience in explanation and accurate definition in the appended claims, the terms “upper” or “lower”, “inner” or “outer” and etc. are used to describe features of the exemplary embodiments with reference to the positions of such features as displayed in the Figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A thermoelectric dehumidifying apparatus comprising:
a housing provided in a widthwise direction of a vehicle adjacent to a windshield glass of the vehicle and having an inlet and an outlet at an upper end thereof;
a thermoelectric module including a thermoelectric element provided between the inlet and the outlet in an interior of the housing and having a surface with which cooling fins make surface-contact and an opposite surface with which heat radiation fins make surface-contact, wherein the thermoelectric element is disposed on a passage of air flowing from the inlet to the outlet such that the air introduced through the inlet passes by the cooling fins and the heat radiation fins at a same time and then is discharged through the outlet; and
a fan provided in the interior of the housing, for guiding the air from the inlet to the outlet.

2. The thermoelectric dehumidifying apparatus of claim 1, wherein the inlet of the housing is formed closer to the windshield glass of the vehicle than the outlet.

3. The thermoelectric dehumidifying apparatus of claim 1, wherein the housing has a closed structure such that air circulates through the inlet and the outlet.

4. The thermoelectric dehumidifying apparatus of claim 1, wherein the cooling fins and the heat radiation fins of the thermoelectric module extend upwards and downwards.

5. The thermoelectric dehumidifying apparatus of claim 1, wherein a water drainage hole is formed at a lower end of the housing.

6. The thermoelectric dehumidifying apparatus of claim 1, wherein the thermoelectric module is disposed on a side close to the inlet and the fan is disposed on a side close to the outlet.

7. The thermoelectric dehumidifying apparatus of claim 1, wherein the heat radiation fins of the thermoelectric module have an air contact area wider than that of the cooling fins.

8. The thermoelectric dehumidifying apparatus of claim 1, wherein a heat transfer mass surface-contacts the opposite surface of the thermoelectric element and a heat transfer pipe is coupled to pass through the heat transfer mass and extends in a widthwise direction of the vehicle in the interior of the housing, and the heat radiation fins are provided at an extending portion of the heat transfer pipe.

9. The thermoelectric dehumidifying apparatus of claim 1, wherein a plate-shaped heat transfer plate extending in a widthwise direction of the vehicle to be coupled is provided on the opposite surface of the thermoelectric element, and the heat radiation fins are coupled to the heat transfer plate.

10. The thermoelectric dehumidifying apparatus of claim 1, wherein the cooling fins and the heat radiation fins are arranged to coincide with a flow direction of the air.

11. The thermoelectric dehumidifying apparatus of claim 1, wherein an insulation partition is provided between the cooling fins and the heat radiation fins in the interior of the housing.

12. The thermoelectric dehumidifying apparatus of claim 11, wherein the insulation partition surrounds the cooling fins to spatially separate the cooling fins and the heat radiation fins.

13. The thermoelectric dehumidifying apparatus of claim 1, wherein the fan is a cross fan disposed in a widthwise direction of the vehicle.

14. The thermoelectric dehumidifying apparatus of claim 1, wherein a front side and an upper side of the housing are opened with respect to the vehicle, a cross fan housing, an upper side and a rear side of which are opened with respect to the vehicle is provided, and the front side of the housing and the rear side of the cross fan housing are coupled to each other to be closed, so that air can circulate through the inlet and the outlet on the upper side of the housing.
